(19) United States
(12) Patent Application Publication
(10) Pub. No.: US 2026/0371155 A1
(43) Pub. Date: Nov. 19, 2026

(54) UPDATING PROTOCOL DATA UNIT SET PARAMETERS BASED ON ANALYTICS IN A WIRELESS COMMUNICATION SYSTEM

(71) Applicant: Lenovo (Singapore) Pte. Limted, Singapore (SG)

(72) Inventors: Emmanouil Pateromichelakis, Viersen (DE); Dimitrios Karampatsis, Ruislip (GB)

(73) Assignee: Lenovo (Singapore) Pte. Limted, Singapore (SG)

(21) Appl. No.: 19/139,280

(22) PCT Filed: Feb. 24, 2023
(86) PCT No.: PCT/EP2023/054717

§ 371 Date: Jun. 13, 2025

(30) Foreign Application Priority Data
Dec. 16, 2022 (GR) 20220101043

(51) Int. Cl. H04W 28/02; H04L 47/80; H04L 65/80

(52) U.S. Cl. CPC H04W 28/0273; H04L 47/801; H04L 65/80; H04W 28/0268

(57) ABSTRACT

There is provided a method in an application entity of a wireless communication system, the method for managing performance of one or more virtual experience applications, the method comprising: receiving a performance parameter for a virtual experience application session; determining a network requirement for the virtual experience application session based on the received performance parameter, wherein the determining the network requirement comprises identifying one of more protocol data unit, PDU, sets for the virtual experience application session; and, based on the determined network requirement, for each of the identified PDU sets, determining a respective PDU set parameter.

### FIELD

The subject matter disclosed herein relates generally to the field of determining and/or updating Protocol Data Unit (PDU) set parameters based on analytics in a wireless communication system or network, in particular analytics related to a virtual experience application service or session, such to the performance or service quality of the as performance virtual experience application service or session.

### INTRODUCTION

Herein, the expression “virtual experience” is an umbrella term for different types of virtual realities, including but not limited to extended Reality (XR), Virtual Reality, Augmented Reality, Mixed Reality the Metaverse. XR may be used itself as an umbrella term for different types of realities of which Virtual Reality, Augmented Reality, and Mixed Reality are examples.

Virtual experience application traffic is subject to strict bandwidth and latency limitations in order to deliver an appropriate Quality of Service and Quality of Experience to an end user of a virtual experience application service. Such strict bandwidth and latency limitations can make delivery of virtual experience application traffic over a wireless communication network challenging.

### SUMMARY

In the context of XR media traffic, 3GPP SA2 Work Group recently introduced the concept of a PDU set′ to group a series of PDUs carrying a unit of information at the application-level. Each PDU within a PDU set can thus be treated according to an identical set of QoS requirements and associated constraints of delay budget and error rate while providing support to a RAN for differentiated QoS handling at PDU set level.

This improves the granularity of legacy 5G QoS flow framework allowing the RAN to optimize the mapping between QoS flow and DRBs to meet stringent XR media requirements (e.g., high-rate transmissions with short delay budget).

Disclosed herein are procedures for collecting data related to XR specific attributes and deriving performance analytics per traffic profiles of traffic within an XR session (e.g. PDU set, media or traffic type, or even per XR session). Said procedures may be implemented by application entity.

There is provided a method in an application entity of a wireless communication system, the method for managing performance of one or more virtual experience applications, the method comprising: receiving a performance parameter for a virtual experience (e.g. XR) application session; determining a network requirement for the virtual experience application session based on the received performance parameter, wherein the determining the network requirement comprises identifying one of more protocol data unit, PDU, sets for the virtual experience application session; and, based on the determined network requirement, for each of the identified PDU sets, determining a respective PDU set parameter.

There is further provided an application entity for a wireless communication system, the application entity comprising: a transceiver; and a processor coupled to the transceiver, the processor and the transceiver configured to cause the application entity to: receive a performance parameter for a virtual experience application session; determine a network requirement for the virtual experience application session based on the received performance parameter, wherein the determination of the network requirement comprises identifying one of more protocol data unit, PDU, sets for the virtual experience application session; and, based on the determined network requirement, for each of the identified PDU sets, determine a respective PDU set parameter.

There is further provided a user equipment, UE, apparatus comprising: a transceiver; and a processor coupled to the transceiver, the processor and the transceiver configured to cause the UE apparatus to: receive configuration information specifying, for each of one or more PDU sets of an virtual experience application session, one or more parameters related to one or more performance attributes of that PDU set; and monitor the one or more parameters of the virtual experience application session in accordance with the received configuration information.

### BRIEF DESCRIPTION OF THE DRAWINGS

In order to describe the manner in which advantages and features of the disclosure can be obtained, a description of the disclosure is rendered by reference to certain apparatus and methods which are illustrated in the appended drawings. Each of these drawings depict only certain aspects of the disclosure and are not therefore to be considered to be limiting of its scope. The drawings may have been simplified for clarity and are not necessarily drawn to scale.

Methods and apparatus for collecting data related to XR specific attributes and deriving performance analytics per traffic profile will now be described, by way of example only, with reference to the accompanying drawings, in which:

FIG. 1 depicts a wireless communication system;

FIG. 2 depicts a user equipment apparatus;

FIG. 3 depicts a network node;

FIG. 4 illustrates an overview of a core network architecture handling of PDU sets;

FIG. 5 illustrates an exemplary XR enabler service;

FIG. 6 illustrates is a process in which an XR Enabler influences PDU set parameters/requirements based on analytics;

FIG. 7 illustrates a process in which PDU set parameters/requirements are updated or influenced based on analytics; and

FIG. 8 is a process flow chart showing certain steps of a method for determining PDU set parameters/requirements.

### DETAILED DESCRIPTION

As will be appreciated by one skilled in the art, aspects of this disclosure may be embodied as a system, apparatus, method, or program product. Accordingly, arrangements described herein may be implemented in an entirely hardware form, an entirely software form (including firmware, resident software, micro-code, etc.) or a form combining software and hardware aspects.

For example, the disclosed methods and apparatus may be implemented as a hardware circuit comprising custom very-large-scale integration (“VLSI”) circuits or gate arrays, off-the-shelf semiconductors such as logic chips, transistors, or other discrete components. The disclosed methods and apparatus may also be implemented in programmable hardware devices such as field programmable gate arrays, programmable array logic, programmable logic devices, or the like. As another example, the disclosed methods and apparatus may include one or more physical or logical blocks of executable code which may, for instance, be organized as an object, procedure, or function.

Furthermore, the methods and apparatus may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In certain arrangements, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store, a program for use by or in connection with an instruction execution system, apparatus, or device.

Reference throughout this specification to an example of a particular method or apparatus, or similar language, means that a particular feature, structure, or characteristic described in connection with that example is included in at least one implementation of the method and apparatus described herein. Thus, reference to features of an example of a particular method or apparatus, or similar language, may, but do not necessarily, all refer to the same example, but mean “one or more but not all examples” unless expressly specified otherwise. The terms “including”, “comprising”, “having”, and variations thereof, mean “including but not limited to”, unless expressly specified otherwise. An enumerated listing of items does not imply that any or all of the items are mutually exclusive, unless expressly specified otherwise. The terms “a”, “an”, and “the” also refer to “one or more”, unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one, and only one, of any single item in the list. For example, “one of A, B and C” includes only A, only B or only C and excludes combinations of A, B and C. As used herein, “a member selected from the group consisting of A, B, and C” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Furthermore, the described features, structures, or characteristics described herein may be combined in any suitable manner. In the following description, numerous specific details are provided, such as examples of programming, software modules, user selections, network transactions, database queries, database structures, hardware modules, hardware circuits, hardware chips, etc., to provide a thorough understanding of the disclosure. One skilled in the relevant art will recognize, however, that the disclosed methods and apparatus may be practiced without one or more of the specific details, or with other methods, components, materials, and so forth. In other instances, well-known structures, materials, or operations are not shown or described in detail to avoid obscuring aspects of the disclosure.

Aspects of the disclosed method and apparatus are described below with reference to schematic flowchart diagrams and/or schematic block diagrams of methods, apparatuses, systems, and program products. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams.

The code may also be loaded onto a computer, other programmable data processing apparatus, or other devices to cause a series of operational steps to be performed on the computer, other programmable apparatus, or other devices to produce a computer implemented process such that the code which executes on the computer or other programmable apparatus provides processes for implementing the functions/acts specified in the schematic flowchart diagrams and/or schematic block diagram.

The schematic flowchart diagrams and/or schematic block diagrams in the Figures illustrate the architecture, functionality, and operation of possible implementations of apparatuses, systems, methods, and program products. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

The description of elements in each figure may refer to elements of proceeding Figures. Like numbers refer to like elements in all Figures.

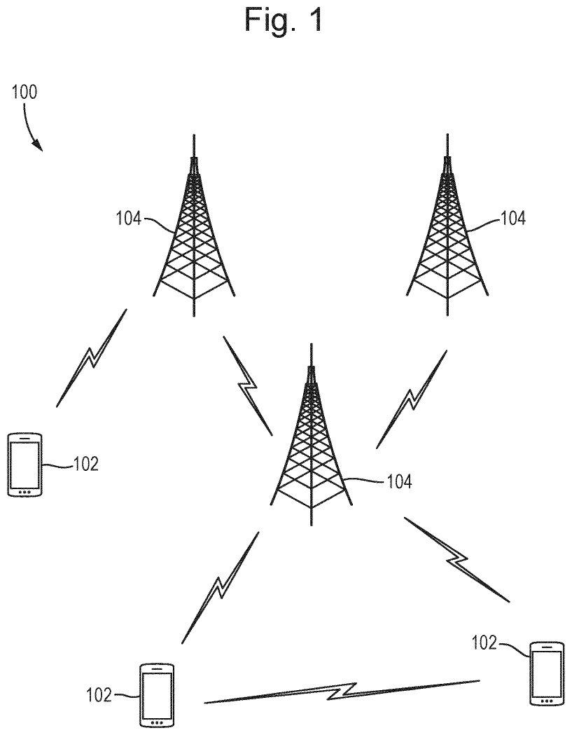

FIG. 1 depicts an embodiment of a wireless communication system 100 in which methods and apparatuses for collecting data related to XR specific attributes and deriving performance analytics per traffic profiles of traffic within an XR session (e.g. PDU set, media or traffic type, or even per XR session) may be implemented. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like.

Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNB, a Home Node-B, a relay node, a device, a core network, an aerial server, a radio access node, an AP, NR, a network entity, an Access and Mobility Management Function (“AMF”), a Unified Data Management Function (“UDM”), a Unified Data Repository (“UDR”), a UDM/UDR, a Policy Control Function (“PCF”), a Radio Access Network (“RAN”), an Network Slice Selection Function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), an application function, a service enabler architecture layer (“SEAL”) function, a vertical application enabler server, an edge enabler server, an edge configuration server, a mobile edge computing platform function, a mobile edge computing application, an application data analytics enabler server, a SEAL data delivery server, a middleware entity, a network slice capability management server, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with New Radio (NR) protocols standardized in 3GPP, wherein the network unit 104 transmits using an Orthogonal Frequency Division Multiplexing (“OFDM”) modulation scheme on the downlink (DL) and the remote units 102 transmit on the uplink (UL) using a Single Carrier Frequency Division Multiple Access (“SC-FDMA”) scheme or an OFDM scheme. More generally, however, the wireless communication system 100 may implement some other open or proprietary communication protocol, for example, WiMAX, IEEE 802.11 variants, GSM, GPRS, UMTS, LTE variants, CDMA2000, Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

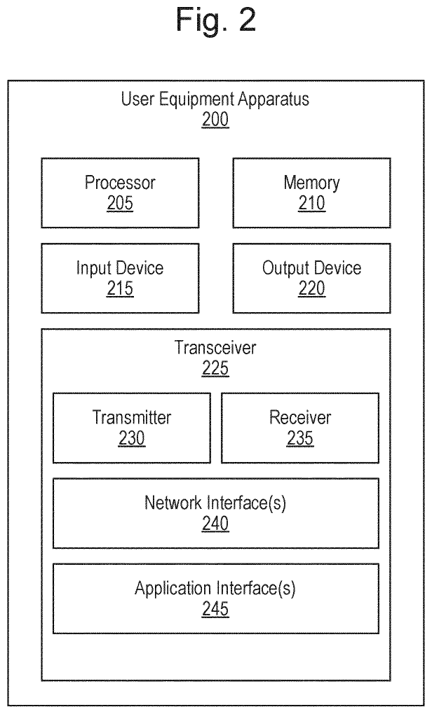

FIG. 2 depicts a user equipment apparatus 200 that may be used for implementing the methods described herein. The user equipment apparatus 200 is used to implement one or more of the solutions described herein. The user equipment apparatus 200 is in accordance with one or more of the user equipment apparatuses described in embodiments herein. In particular, the user equipment apparatus 200 may be in accordance with or the same as the remote unit 102 of FIG. 1. The user equipment apparatus 200 includes a processor 205, a memory 210, an input device 215, an output device 220, and a transceiver 225.

The input device 215 and the output device 220 may be combined into a single device, such as a touchscreen. In some implementations, the user equipment apparatus 200 does not include any input device 215 and/or output device 220. The user equipment apparatus 200 may include one or more of: the processor 205, the memory 210, and the transceiver 225, and may not include the input device 215 and/or the output device 220.

As depicted, the transceiver 225 includes at least one transmitter 230 and at least one receiver 235. The transceiver 225 may communicate with one or more cells (or wireless coverage areas) supported by one or more base units. The transceiver 225 may be operable on unlicensed spectrum. Moreover, the transceiver 225 may include multiple UE panels supporting one or more beams. Additionally, the transceiver 225 may support at least one network interface 240 and/or application interface 245. The application interface(s) 245 may support one or more APIs. The network interface(s) 240 may support 3GPP reference points, such as Uu, N1, PC5, etc. Other network interfaces 240 may be supported, as understood by one of ordinary skill in the art.

The processor 205 may include any known controller capable of executing computer-readable instructions and/or capable of performing logical operations. For example, the processor 205 may be a microcontroller, a microprocessor, a central processing unit (“CPU”), a graphics processing unit (“GPU”), an auxiliary processing unit, a field programmable gate array (“FPGA”), or similar programmable controller. The processor 205 may execute instructions stored in the memory 210 to perform the methods and routines described herein. The processor 205 is communicatively coupled to the memory 210, the input device 215, the output device 220, and the transceiver 225.

The processor 205 may control the user equipment apparatus 200 to implement the user equipment apparatus behaviors described herein. The processor 205 may include an application processor (also known as “main processor”) which manages application-domain and operating system (“OS”) functions and a baseband processor (also known as “baseband radio processor”) which manages radio functions.

The memory 210 may be a computer readable storage medium. The memory 210 may include volatile computer storage media. For example, the memory 210 may include a RAM, including dynamic RAM (“DRAM”), synchronous dynamic RAM (“SDRAM”), and/or static RAM (“SRAM”). The memory 210 may include non-volatile computer storage media. For example, the memory 210 may include a hard disk drive, a flash memory, or any other suitable non-volatile computer storage device. The memory 210 may include both volatile and non-volatile computer storage media.

The memory 210 may store data related to implement a traffic category field as described herein. The memory 210 may also store program code and related data, such as an operating system or other controller algorithms operating on the apparatus 200.

The input device 215 may include any known computer input device including a touch panel, a button, a keyboard, a stylus, a microphone, or the like. The input device 215 may be integrated with the output device 220, for example, as a touchscreen or similar touch-sensitive display. The input device 215 may include a touchscreen such that text may be input using a virtual keyboard displayed on the touchscreen and/or by handwriting on the touchscreen. The input device 215 may include two or more different devices, such as a keyboard and a touch panel.

The output device 220 may be designed to output visual, audible, and/or haptic signals. The output device 220 may include an electronically controllable display or display device capable of outputting visual data to a user. For example, the output device 220 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 220 may include a wearable display separate from, but communicatively coupled to, the rest of the user equipment apparatus 200, such as a smart watch, smart glasses, a heads-up display, or the like. Further, the output device 220 may be a component of a smart phone, a personal digital assistant, a television, a table computer, a notebook (laptop) computer, a personal computer, a vehicle dashboard, or the like.

The output device 220 may include one or more speakers for producing sound. For example, the output device 220 may produce an audible alert or notification (e.g., a beep or chime). The output device 220 may include one or more haptic devices for producing vibrations, motion, or other haptic feedback. All, or portions, of the output device 220 may be integrated with the input device 215. For example, the input device 215 and output device 220 may form a touchscreen or similar touch-sensitive display. The output device 220 may be located near the input device 215.

The transceiver 225 communicates with one or more network functions of a mobile communication system or network via one or more access networks. The transceiver 225 operates under the control of the processor 205 to transmit messages, data, and other signals and also to receive messages, data, and other signals. For example, the processor 205 may selectively activate the transceiver 225 (or portions thereof) at particular times in order to send and receive messages.

The transceiver 225 includes at least one transmitter 230 and at least one receiver 235. The one or more transmitters 230 may be used to provide uplink communication signals to a base unit of a wireless communication system. Similarly, the one or more receivers 235 may be used to receive downlink communication signals from the base unit. Although only one transmitter 230 and one receiver 235 are illustrated, the user equipment apparatus 200 may have any suitable number of transmitters 230 and receivers 235. Further, the transmitter(s) 230 and the receiver(s) 235 may be any suitable type of transmitters and receivers. The transceiver 225 may include a first transmitter/receiver pair used to communicate with a mobile communication system over licensed radio spectrum and a second transmitter/receiver pair used to communicate with a mobile communication system over unlicensed radio spectrum.

The first transmitter/receiver pair may be used to communicate with a mobile communication system over licensed radio spectrum and the second transmitter/receiver pair used to communicate with a mobile communication system over unlicensed radio spectrum may be combined into a single transceiver unit, for example a single chip performing functions for use with both licensed and unlicensed radio spectrum. The first transmitter/receiver pair and the second transmitter/receiver pair may share one or more hardware components. For example, certain transceivers 225, transmitters 230, and receivers 235 may be implemented as physically separate components that access a shared hardware resource and/or software resource, such as for example, the network interface 240.

One or more transmitters 230 and/or one or more receivers 235 may be implemented and/or integrated into a single hardware component, such as a multi-transceiver chip, a system-on-a-chip, an Application-Specific Integrated Circuit (“ASIC”), or other type of hardware component. One or more transmitters 230 and/or one or more receivers 235 may be implemented and/or integrated into a multi-chip module. Other components such as the network interface 240 or other hardware components/circuits may be integrated with any number of transmitters 230 and/or receivers 235 into a single chip. The transmitters 230 and receivers 235 may be logically configured as a transceiver 225 that uses one more common control signals or as modular transmitters 230 and receivers 235 implemented in the same hardware chip or in a multi-chip module.

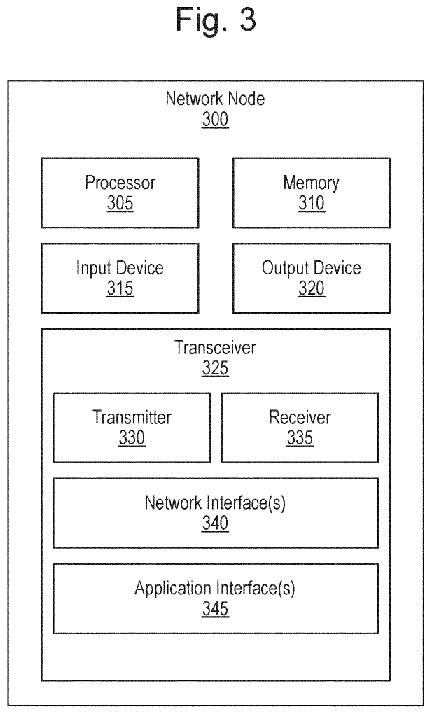

FIG. 3 depicts further details of the network node 300 that may be used for implementing the methods described herein. The network node 300 may be one implementation of an entity in the wireless communications network, e.g. in one or more of the wireless communications networks described herein, e.g. the wireless communication system 100 of FIG. 1. In particular, the network node 300 may be in accordance with or the same as the network unit 104 of FIG. 1. The network node 300 may be, for example, the UE apparatus 200 described above, or a Network Function (NF) or Application Function (AF), or another entity, of one or more of the wireless communications networks of embodiments described herein, e.g. the wireless communication system 100 of FIG. 1. The network node 300 includes a processor 305, a memory 310, an input device 315, an output device 320, and a transceiver 325.

The input device 315 and the output device 320 may be combined into a single device, such as a touchscreen. In some implementations, the network node 300 does not include any input device 315 and/or output device 320. The network node 300 may include one or more of: the processor 305, the memory 310, and the transceiver 325, and may not include the input device 315 and/or the output device 320.

As depicted, the transceiver 325 includes at least one transmitter 330 and at least one receiver 335. Here, the transceiver 325 communicates with one or more remote units 200. Additionally, the transceiver 325 may support at least one network interface 340 and/or application interface 345. The application interface(s) 345 may support one or more APIs. The network interface(s) 340 may support 3GPP reference points, such as Uu, N1, N2 and N3. Other network interfaces 340 may be supported, as understood by one of ordinary skill in the art.

The processor 305 may include any known controller capable of executing computer-readable instructions and/or capable of performing logical operations. For example, the processor 305 may be a microcontroller, a microprocessor, a CPU, a GPU, an auxiliary processing unit, a FPGA, or similar programmable controller. The processor 305 may execute instructions stored in the memory 310 to perform the methods and routines described herein. The processor 305 is communicatively coupled to the memory 310, the input device 315, the output device 320, and the transceiver 325.

The memory 310 may be a computer readable storage medium. The memory 310 may include volatile computer storage media. For example, the memory 310 may include a RAM, including dynamic RAM (“DRAM”), synchronous dynamic RAM (“SDRAM”), and/or static RAM (“SRAM”). The memory 310 may include non-volatile computer storage media. For example, the memory 310 may include a hard disk drive, a flash memory, or any other suitable non-volatile computer storage device. The memory 310 may include both volatile and non-volatile computer storage media.

The memory 310 may store data related to establishing a multipath unicast link and/or mobile operation. For example, the memory 310 may store parameters, configurations, resource assignments, policies, and the like, as described herein. The memory 310 may also store program code and related data, such as an operating system or other controller algorithms operating on the network node 300.

The input device 315 may include any known computer input device including a touch panel, a button, a keyboard, a stylus, a microphone, or the like. The input device 315 may be integrated with the output device 320, for example, as a touchscreen or similar touch-sensitive display. The input device 315 may include a touchscreen such that text may be input using a virtual keyboard displayed on the touchscreen and/or by handwriting on the touchscreen. The input device 315 may include two or more different devices, such as a keyboard and a touch panel.

The output device 320 may be designed to output visual, audible, and/or haptic signals. The output device 320 may include an electronically controllable display or display device capable of outputting visual data to a user. For example, the output device 320 may include, but is not limited to, an LCD display, an LED display, an OLED display, a projector, or similar display device capable of outputting images, text, or the like to a user. As another, non-limiting, example, the output device 320 may include a wearable display separate from, but communicatively coupled to, the rest of the network node 300, such as a smart watch, smart glasses, a heads-up display, or the like. Further, the output device 320 may be a component of a smart phone, a personal digital assistant, a television, a table computer, a notebook (laptop) computer, a personal computer, a vehicle dashboard, or the like.

The output device 320 may include one or more speakers for producing sound. For example, the output device 320 may produce an audible alert or notification (e.g., a beep or chime). The output device 320 may include one or more haptic devices for producing vibrations, motion, or other haptic feedback. All, or portions, of the output device 320 may be integrated with the input device 315. For example, the input device 315 and output device 320 may form a touchscreen or similar touch-sensitive display. The output device 320 may be located near the input device 315.

The transceiver 325 includes at least one transmitter 330 and at least one receiver 335. The one or more transmitters 330 may be used to communicate with the UE, as described herein. Similarly, the one or more receivers 335 may be used to communicate with network functions in the PLMN and/or RAN, as described herein. Although only one transmitter 330 and one receiver 335 are illustrated, the network node 300 may have any suitable number of transmitters 330 and receivers 335. Further, the transmitter(s) 330 and the receiver(s) 335 may be any suitable type of transmitters and receivers.

In Release 18, 3GPP is studying enhancements to support XR (extended reality) media within 3GPP core network. The main principle of solutions being discussed is to allow the core network to guarantee delivery of media packets that are important at the application level for recovering the media traffic even when the media packet is sent via a best effort bearer.

Most of the solutions proposes in 3GPP SA2 propose that the network identify important packets in a PDU-set. The PDU-set terminology in 3GPP TR 23.700-60 is as follows:
PDU Set: A PDU Set is composed of one or more PDUs carrying the payload of one unit of information generated at the application level (e.g. a frame or video slice for XRM Services, as used in TR 26.926. In some implementations all PDUs in a PDU Set are needed by the application layer to use the corresponding unit of information. In other implementations, the application layer can still recover parts all or of the information unit, when some PDUs are missing.

PDU-set specific QoS requirements may be defined that are either pre-configured in the 3GPP core network or provided by an AF. The QoS requirements for a PDU-set may be defined using any combination of the following parameters:
PDU Set Delay Budget (PSDB);
PDU Set Error Rate (PSER); and
Whether a PDU is essential.

The term PDU Set Delay Budget (PSDB) is used herein to define an upper bound for the time that a PDU-Set may be delayed between the UE and the N6 termination point at the UPF. PSDB applies to the DL PDU-Set received by the UPF over the N6 interface, and to the UL PDU-Set sent by the UE.

The term PDU Set Error Rate (PSER) is used herein to define a ratio of dropped PDU-set by NG-RAN compared to total PDU-set sent to the UE.

Whether a PDU is essential indicates whether all PDUs of a PDU-set are required by a receiver.

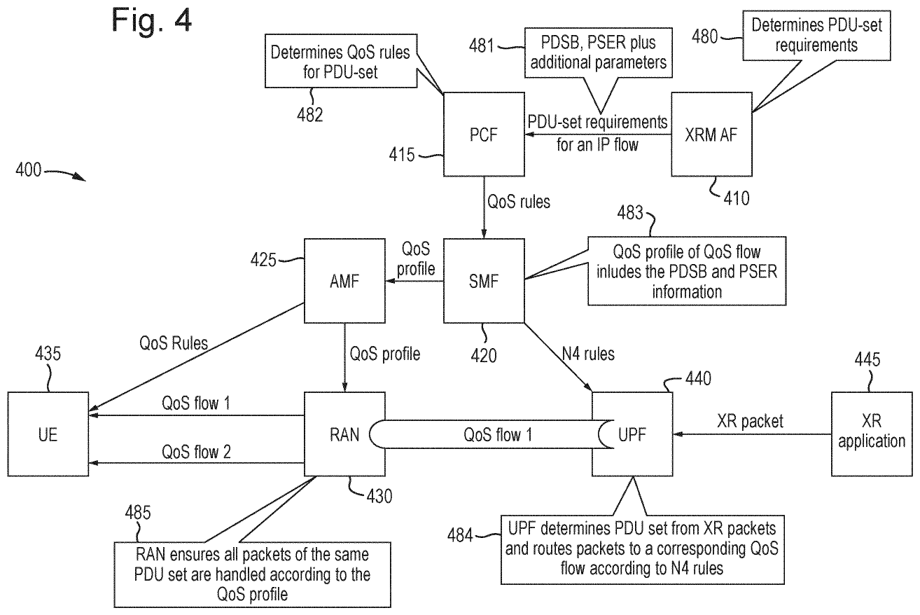

The packets belonging to a PDU-set are handled by the core network as shown in FIG. 4 which illustrates an overview of a core network (CN) XRM architecture handling of PDU sets. FIG. 4 shows a system 400 comprising an Extended Reality Media Application Function (XRM AF) 410, a Policy and Control Function (PCF) 415, a Session Management Function (SMF) 420, an Access and Mobility Function (AMF) 425, a Radio Access Network (RAN) 430, a User Equipment (UE) 435, a User Plane Function (UPF) 440, and an Extended Reality Application 445. The UE 435 may comprise a remote unit 102 or a user equipment apparatus 200 as described herein. The RAN 430 may comprise a base unit 104 or a network node 300 as described herein. The operation of system 400 will now be described in the example of downlink traffic, a similar process may operate for uplink traffic.

At 480, the XRM AF 410 determines PDU set requirements.

At 481, the XRM Application Function 410 provides QoS requirements for packets of a PDU set to the PCF 415 and information to identify the application (i.e. 4-tuple or application id). The QoS requirements may comprise PSDB and PSER. The XRM AF 410 may also include an importance parameter for a PDU set and information for the core network to identify packets belonging to a PDU set.

At 482, the PCF 415 derives QoS rules for the XR application and specific QoS requirements for the PDU set. The QoS rules may use a 4G QoS identifier (5QI) for XR media traffic. The PCF 415 sends the QoS rules to the SMF 420. The PCF 415 may include in the communication to the SMF 420 Policy and Charging Control (PCC) rules per importance of a PDU set. The PCC rules may be derived according to information received from the XRM AF 410 or based on an operator configuration.

At 483, the SMF 420 establishes a QoS flow according to the QoS rules by the PCF 415 and configures the UPF to route packets of the XR application to a QoS flow, and, in addition, to enable PDU set handling. The SMF 420 also provides the QoS profile containing PDU set QoS requirements to the RAN 430 via the AMF 425. The AMF 425 may provide the QoS profile containing PDU set QoS requirements to the RAN 430 in an N2 Session Management (SM) container. Further, the AMF 425 may provide the QoS rules to the UE 435 in an N1 SM container.

At 484, the UPF 440 inspects the packets and determines packets belonging to a PDU set. The packet inspection may comprise inspecting the RTP packets. When the UPF 440 detects packets of a PDU set the UPF 440 marks the packets belonging to a PDU set within a GTP-U header. The GTP-U header information includes a PDU set sequence number and the size of the PDU set. The UPF 440 may also determine the importance of the PDU set either based on UPF 440 implementation means, information provided by the XRM AF 410 or information provided as metadata from an XRM application server. Based on the importance of the PDU set the UPF 440 may route the traffic to a corresponding QoS flow 1 (according to the rules received from the SMF 420) or include the importance of the PDU set within a GTP-U header. QoS flow 1 may comprise GTP-U headers, and these may include PDU set information.

At 485, the RAN 430 identifies packets belonging to a PDU set (based on the GTP-U marking) and handles the packets of the PDU set according to the QoS requirements of the PDU set provided by the SMF 420. RAN 430 may receive QFIs, QoS profile of QoS flow from SMF 420 (via AMF 425) during PDU session establishment/modification which includes PDSB and PSER. RAN 430 inspects GTP-U headers and ensures all packets of the same PDU set are handled according to the QoS profile. This may include packets of PDU set in a radio bearer carrying QoS flow 1. This may also include sending packets not belonging to the PDU set in a different radio bearer carrying QoS flow 2.

The above example relates to downlink (DL) traffic. Reciprocal processing is applicable to uplink (UL) traffic wherein the role of UPF 440 packet inspection is taken by the UE 435 which is expected to inspect uplink packets, determine packets belonging to a PDU set, and signal accordingly the PDU set to the RAN 430 for scheduling and resource allocation corresponding to an associated DRB capable of fulfilling the PDU set QoS requirements (i.e., PSDB and PSER). The low-level signaling mechanism associated with the UL UE-to-RAN information passing are up to the specification and implementations of RAN signaling procedures.

Herein, extended Reality (XR) is used as an umbrella term for different types of realities, of which Virtual Reality, Augmented Reality, and Mixed Reality are examples.

Virtual Reality (VR) is a rendered version of a delivered visual and audio scene. The rendering is in this case designed to mimic the visual and audio sensory stimuli of the real world as naturally as possible to an observer or user as they move within the limits defined by the application. Virtual reality usually, but not necessarily, requires a user to wear a head mounted display (HMD), to completely replace the user's field of view with a simulated visual component, and to wear headphones, to provide the user with the accompanying audio. Some form of head and motion tracking of the user in VR is usually also necessary to allow the simulated visual and audio components to be updated to ensure that, from the user's perspective, items and sound sources remain consistent with the user's movements. In some implementations additional means to interact with the virtual reality simulation may be provided but are not strictly necessary.

Augmented Reality (AR) is when a user is provided with additional information or artificially generated items, or content overlaid upon their current environment. Such additional information or content will usually be visual and/or audible and their observation of their current environment may be direct, with no intermediate sensing, processing, and rendering, or indirect, where their perception of their environment is relayed via sensors and may be enhanced or processed.

Mixed Reality (MR) is an advanced form of AR where some virtual elements are inserted into the physical scene with the intent to provide the illusion that these elements are part of the real scene.

XR refers to all real-and-virtual combined environments and human-machine interactions generated by computer technology and wearables. It includes representative forms such as AR, MR and VR and the areas interpolated among them. The levels of virtuality range from partially sensory inputs to fully immersive VR. In some circles, a key aspect of XR is considered to be the extension of human experiences especially relating to the senses of existence (represented by VR) and the acquisition of cognition (represented by AR).

In 3GPP Release 17, 3GPP SA4 Working Group analyzed the Media transport Protocol and XR traffic model in the Technical Report TR 26.926 (v1.1.0) titled “Traffic Models and Quality Evaluation Methods for Media and XR Services in 5G Systems”, and decided the QoS requirements in terms of delay budget, data rate and error rate necessary for a satisfactory experience at the application level. These led to 4 additional 5G QoS Identifiers (5QIs) for the 5GS XR QoS flows. These 5Qis are defined in 3GPP TS 23.501 (v17.5.0), Table 5.7.4-1, presented there as delay-critical GBR 5QIs valued 87-90. The latter are applicable to XR video streams and control metadata necessary to provide the immersive and interactive XR experiences.

The XR video traffic is mainly composed of multiple DL/UL video streams of high resolution (e.g., at least 1080p dual-eye buffer usually), frames-per-second (e.g., 60+ fps) and high bandwidth (e.g., usually at least 20-30 Mbps) which needs to be transmitted across a network with minimal delay (typically upper bounded by 15-20 ms) to maintain a reduced end-to-end application round-trip interaction delay. The latter requirements are of critical importance given the XR application dependency on cloud/edge processing (e.g., content downloading, viewport generation and configuration, viewport update, viewport rendering, media encoding/transcoding etc.).

The following additional assumptions have also been agreed:
NG-RAN is the only entity that drops packet of a PDU-set in case of congestion.
For a QoS flow there can be multiple priority PDU-sets. The NG-RAN drops the lower priority PDU-sets in case of congestions.
The NG-RAN drops all PDUs of a PDU-set

The Analytics Consumer NF may be one or more of an AF, OAM and 5G Core NFs (e.g., SMF, AMF, PCF). A full list of potential Analytics Consumer NF for each Analytics output the NWDAF provides is described in table 1 below.

TABLE 1
Example Analytics Consumer NFs

| NWDAF Analytics Output | Example Analytics Consumer NF |
|---|---|
| Slice Load Level | PCF, NSSF |
| Observed Service Experience | PCF, OAM |
| NF load analytics | All 5G core NFs, OAM |
| Network Performance Analytics | PCF, NEF, AF, or OAM |
| UE Mobility Analytics | AMF, SMF |
| UE Communication Analytics | AMF, SMF, PCF |
| Expected UE behavioural analytics | AMF, UDM, AF or OAM |
| Abnormal behaviour analytics | AMF, SMF, PCF |
| User Data Congestion analytics | NEF, AF |
| QoS Sustainability Analytics | AF |

In particular, to support XR services, the following analytics are relevant to this disclosure. Such analytics can be beneficial for mobile XR users, or for the XR service provider/vertical who needs to deploy the XRM service in a target area and time (e.g. for an event) and who requires the statistics/predictions on the QoS/network performance and availability.

Observed experience analytics provide an indication of a service consumer experience for application traffic when routed via the 3GPP network. Examples include the average of observed Service MoS and/or variance of observed Service MoS indicating service MOS distribution for services such as audio-visual streaming as well as services that are not audio-visual streaming such as V2X and Web Browsing services.

QoS Sustainability Analytics provide information regarding the QoS change statistics for an Analytics target period in the past in a certain area, or the likelihood of a QoS change for an Analytics target period in the future in a certain area.

Network Performance Analytics provide either statistics or predictions on the gNB status information, gNB resource usage, communication performance and mobility performance in an Area of Interest.

User Data Congestion Analytics provide User Data Congestion related analytics which can relate to congestion experienced while transferring user data over the control plane or user plane or both.

In addition, in 3gpp SA6, enablement services include analytics enablement at the edge/vertical domain. More specifically:

An Application Data Analytics Enablement Service (ADAES), as specified in TS 23.436 and TS 23.434, provides analytics services for the application server or application session (e.g., between two UEs or a UE and the server) as well as analytics services for edge load/performance. One example is the collection of measurements/analytics from the UE side on QoS/QoE, as well as from 5GC and OAM, and deriving analytics (e.g., stats/predictions) on the app server performance (e.g., a gaming server, or an IIOT server).

A Network Slice Capability Enablement (NSCE) service, as specified in TS 23.435 and TS 23.434, provides slice enablement services. One of these services is as specified in TS 23.435 clause 9.7 about Network slice related performance and analytics monitoring. In this service, an NSCE server collects KQI data of services, the network performance related data and the end user's information from NSCE client, as well as slice related analytics from 5GC/OAM, and exposes performance data and analytics related to the slice to the vertical customer.

A SEAL-Data Delivery (SEAL-DD) service (see, for example TR 23.700-34, TS 23.433) includes studying a specific KI (clause 4.3 of 23.700-34) of the measurement of data transmission quality (including, for example, end to end latency) between SEALDD client (UE) and SEALDD server (optionally co-located with a VAL server). Such application quality measurements can be used by the vertical server to allow for application layer service adaptions.

Other SEAL services (like network resource management) may provide translation capabilities for monitoring and allowing QoS adaptation triggering at the application layer.

Since XR services are about verticals, the enablement layer can be enhanced to support QoS/QoE translation and analytics enablement for XR applications. This can be by enhancement of existing enablers, or a new XR enabler service.

The QoS/QoE requirements and data can refer to metrics that can differ for different traffic types within the XR application. For XR sessions, the data needed for different traffic types can be as follows:
For video data: latency, PER, XR MOS, stalling events, stalling ratios, throughput, PSDB and PSER, encoding rate/video quality, min-max frame rate, other QoE aspects.
For sensor data: e2e latency, availability, reliability, data freshness, group/clustering info and connection density.
For haptics-related data: Packet Size, Reliability (%), Latency (ms), Average Data rate.
Per PDU set: PSDB and PSER, encoding rate/video quality per set, importance factor/priorities, packet drop rates per PDU set, jitter.
For XR sessions: QoE metrics including immersion (“credibility” of XR effects), application QoS metrics (e.g., latency, jitter, reliability, rate, etc.) which may be aggregated or min-max per XR session, roundtrip interaction delay, user interaction delay.

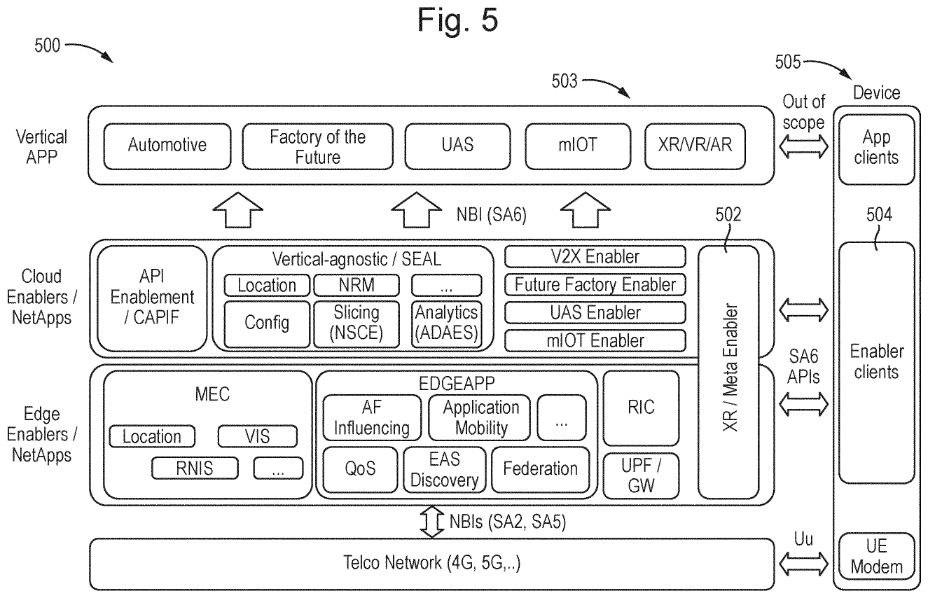

FIG. 5 is a schematic illustration showing an exemplary XR enabler service 500.

As shown in FIG. 5, the XR (e.g. Metaverse) enabler can include two logical entities/modules. These are as follows:

An XR enabler server 502 at the DN/EDN side 503 which includes the server-side middleware capabilities, for example, as a PaaS/SaaS at the edge/cloud provider or vertical domain.

An XR enabler client 504 at the UE side 505 which may provide measurements/data on the XR application session performance (e.g., for UE to UE and UE to network sessions) as well as reporting relevant data to the XR enabler server 502.

The XR enabler server 502 can be a logical entity included within any other enabler (or group of enablers) or may consume enablement services related to XR (e.g., metaverse) app services.

The XR enabler service or server or function is a newly proposed middleware entity at the platform and/or UE side which is configured to provide exposure and translation capabilities to virtual experience application services. Such capabilities may include for example the QoS requirements translation and may interact via APIs with the XR applications as well as via interfaces to the core network.

One problem to be solved is how to enable awareness on the observed service experience of the application based on the PDU set marking, and how to proactively act, for example upon an indication of possible predictive change, to ensure meeting the XRM service requirements.

The XRM service can be also defined or referred to as the XR application service or the XR service.

The XRM server, XR application server and XR server may be the same or equivalent entities.

The XR application may have server and client counterparts.

Described herein is a mechanism for XRM (e.g., mobile metaverse) tailored service optimization triggered by the AF or the Enabler/Middleware entity.

Described herein is a method performed at an application entity, which can be a trusted AF or an XR enabler server or any other enablement service. The method comprises the following steps:
1. The XR application/vertical subscribes for enablement services, for example, to the XR Enabler/AF). The enablement services include the support for monitoring, notifying and/or influencing the QoS parameters for one or more XR sessions for one or more XR UEs. Optionally, the server can provide a list of video qualities which are acceptable for the XR session.
2. The XR AF/Enabler determines the PDU sets for the XR application session or service, based on the application QoS/QoE requirement. It also determines the per PDU set parameters (e.g., PSDB and PSER) and importance per PDU set. This determination can be based on analytics and/or statistics on the QoS per different traffic and/or media types/PDU sets. These analytics can be provided by, for example, the NWDAF or ADAES.
3. The XR AF/Enabler configures the monitoring for the XR sessions, which may be differentiated for different traffic per XR session and PDU sets (e.g., i-frames, p-frames, sensor data, haptic data, etc.). The monitoring requirement can be per video quality/encoding rate
4. The XR AF/Enabler sends the configurations (i.e. the determined configuration information) to the XR users. This may include the PDU set information and monitoring configuration, based on steps 2 and/or 3 above.
5. The XR AF/Enabler, upon receiving a monitoring event, triggers the adaptation of the QoS requirements and/or the importance factor per PDU set to ensure that the per XR session application QoS requirements is met.
6. The XR AF/Enabler notifies both the XR application/vertical as well as the network/user for the adaptation of the PDU set information, and in particular the QoS requirements and/or the importance factor for one or more PDU sets within the XR application.

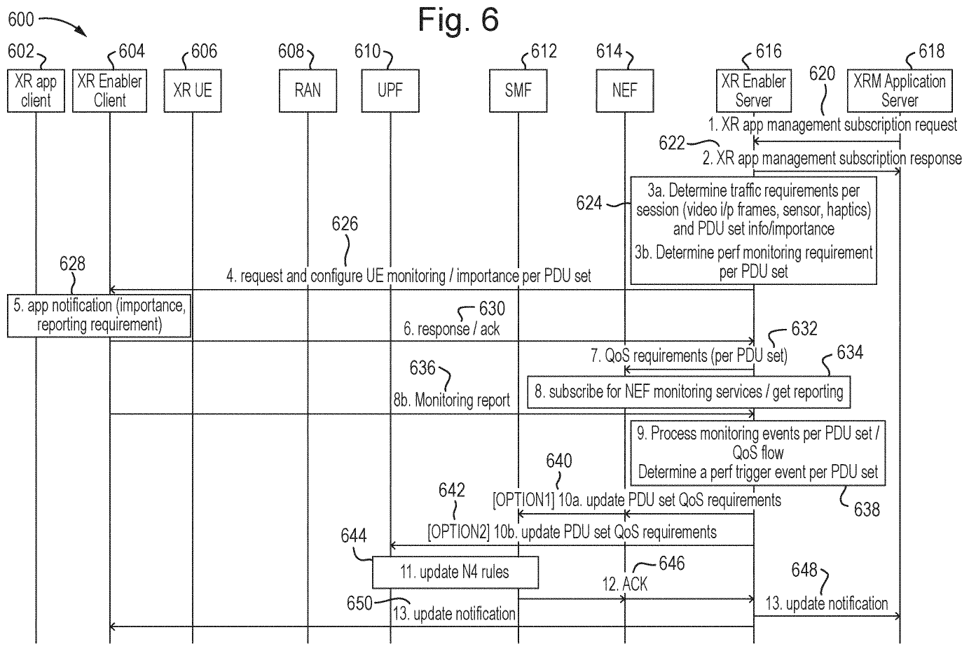

What will now be described, with reference to FIG. 6, is an embodiment in which the XR Enabler influences PDU set parameters/requirements based on NWDAF analytics.

FIG. 6 is a schematic illustration illustrating a process 600 in which the XR Enabler influences PDU set parameters/requirements based on NWDAF analytics.

The process 600 may involve an XR application/enabler client 602, an XR enabler client 604, an XR UE 606, a RAN 608, a UPF 610, an SMP 612, a NEF 614, an XR enabler server 616, and an XRM application server 618.

The XR application/enabler client 602, the XR enabler client 604, the XR UE 606, the RAN 608, the UPF 610, the SMP 612, the NEF 614, the XR enabler server 616, and the XRM application server 618 may be the same as or in accordance with any network entity, function, or node described herein. For example, the XR enabler client 604, the XR UF 606, the RAN 608, the UPF 610, the SMP 612, the NEF 614, the XR enabler server 616, and/or the XRM application server 618 may be the same as the network node 300 shown in FIG. 3 and described in more detail earlier above. The XR UE 606 may be the same as or in accordance with any of the UEs described herein. For example, XR UE 606 may be the same as the UE 200 shown in FIG. 2 and described in more detail earlier above. The XR application/enabler client 602 and the XR enabler client 604 may be located at UEs (e.g. XR UE 606) which may be the same as or in accordance with any of the UEs described herein, for example the UE 200 shown in FIG. 2 and described in more detail earlier above.

The following pre-conditions for the method 600 may apply:
The XR enabler server may be authorized as a trusted AF to manage the XR applications for a target area (e.g. a PLMN, TA/cell, edge service area, and/or slice area).
The XR enabler server may have received from OAM/management system the relevant configurations for the PDU set types and supported traffic/target KPIs.

At 620, the XRM application server 618 sends a subscription request (or request) to the XR enabler server 616 (or service or function) to subscribe for XR related enablement services. Such service may be those provided, for example, at an edge platform/telco cloud. Such services may be for a given application service or session. Such a session can be, for example, related to an XR-enabled multiplayer/single player game or to a mobile metaverse service. The request may include the application QoS/QoE requirements per XR session/service, the area and time of interest and the list of capabilities and exposure level which is needed. The request may include the slice/slice instance in which the XRM service is expected to connect to.

At 622, the XR enabler server 616 authorizes the request (possibly with the support of a management system) and sends a subscription response the to XRM application server 618. The subscription response may be a positive or negative result.

At 624, the XR enabler server 616 determines, based on the application QoS requirements, the QoS targets per session and per PDU set. The XR enabler server 616 may first identify the PDU sets (or such information may be given) and may map the identified PDU sets to QoS attributes and the importance parameter for a PDU-set and information for the core network to identify packets belonging to a PDU-set.

In this embodiment, XR enabler server 616 identifies, based on the XR application requirement, the PDU sets to be used and their information (for example, using the knows the traffic types and characteristics).

The PDU set configuration is discussed in 3GPP TR 23.700-60. For XR/media services, a group of packets are used to carry payloads of a PDU Set (e.g. a frame, video slice/tile). In the media layer, packets in such a PDU Set are decoded/handled as a whole. For example, the frame/video slice may be decoded in cases where all or certain amount of the packets carrying the frame/video slice are successfully delivered. For example, a frame within a GOP (Group of Pictures) can only be decoded by the client in case all frames on which that frame depends are successfully received.

This determination of the QoS targets per session and per PDU set can be based on analytics/statistics on the QoS per different traffic types/PDU sets. These analytics can be provided, for example, by the NWDAF or the ADAES, and may be based on a subscription/request.

In this step (i.e. at 624), the XR enabler server 616 can also identify the monitoring requirement per PDU set within the XR session. This means that for video related PDU sets or haptic/sensor related PDU sets, the performance QoS monitoring from the UEs may be different. The triggering criteria and/or the frequency/thresholds of the reporting of monitoring events may different based on the type of traffic. For example, for video data, the MOS, stalling events-ratio, and/or packet drop rates per PDU set type can be reported, while for sensor data the monitored parameters can include PER, latency, and/or number of retransmissions.

At 626, XR enabler server 616 connects (i.e., establishes session or makes a request) to XR enabler clients 604 at the UEs (e.g. XR UEs 606) within the XR service area, and configures the reporting for the monitoring of performance of the XR sessions, per type of traffic/PDU Set.

At 628, the XR enabler client 604 applies the configuration and also notifies the XR application client 602 on the PDU sets and the importance information for the UL. The XR enabler client 604 may send the mapping (e.g. a mapping table including the mapping between PDU set/i-frame and importance) to the XR application client 602.

At 630, the XR enabler client 604 sends a response to the enabler server 616.

At 632, the XR enabler server 616 creates and sends an AF request to the NEF 614, thereby to provide to the NEF 614 the QoS requirements and importance per PDU set. Further steps may occur at the 5GS, such as those described in more detail above with reference to FIG. 4.

At 634, the XR enabler server 616 subscribes for network/QoS monitoring events to the NET 614. Such subscription can be per PDU set or collectively per XR session, and may include subscriptions for all events needed for all traffic types within the XR session.

At 636, the XR enabler server 614 receives monitoring events based on the subscription 634.

The XR enabler server 616 may also subscribe and receive real time analytics to the ADAES and/or the NWDAF related to predictions of the XR session/PDU set performance.

At 638, the XR enabler server 616 processes or evaluates the received monitoring events. The monitoring events may include, but are not limited to, a QoS downgrade indication, a network congestion expectation. Based, for example, on the target KPI(s) per XR sessions and per PDU set QoS targets, the XR enabler server 616 determines an action to be performed. This action may be updating of the QoS profile or making a request for more resources for one or more PDU sets. The objective of this action may be to ensure meeting the end-to-end XR session requirements (including multimodal traffic). The requesting of resources, e.g. additional resources, may comprise sending to the 5GC (e.g. to the SMF via the NEF or to the PCF via N5) a request for a change of the QoS profile mapped to the respective network session/PDU set or the update of the PCC rules to apply the new traffic policy. This may be as specified in 3GPP TS 23.502, in clause 4.15.6.6a: AF session with required QoS update procedure.

At 640 and 642, the determined action may be performed, e.g. by the XR enabler server 616. In this embodiment, the XR enabler server 616 sends 640 the updated QoS parameters/requirements either to the SMF 612 via the NEF 614 (via control plane), or sends 642 the updated QoS requirements to the UPF 610 (via user plane, if the XR enabler server 616 interacts via N6 with UPF 610).

At 644, the 5GC (i.e. the SMF 612 or the PCF) updates PCC rules based on the XR enabler server request.

At 646, the 5GC provides a response or acknowledgment (ACK) to the XR enabler server 616. This may be provided via the NEF 614 or directly.

At 648, the XR enabler server 616 notifies the involved XR enabler clients 604 of the updated QoS parameters per XR session. In this step, the notification may also include some expected/predicted performance downgrade and/or an alert to adapt the application behavior (for example, to adapt the encoding rate for video traffic e.g. in accordance with the determined action).

Thus, a process in which the XR Enabler influences PDU set parameters/requirements based on NWDAF analytics is provided.

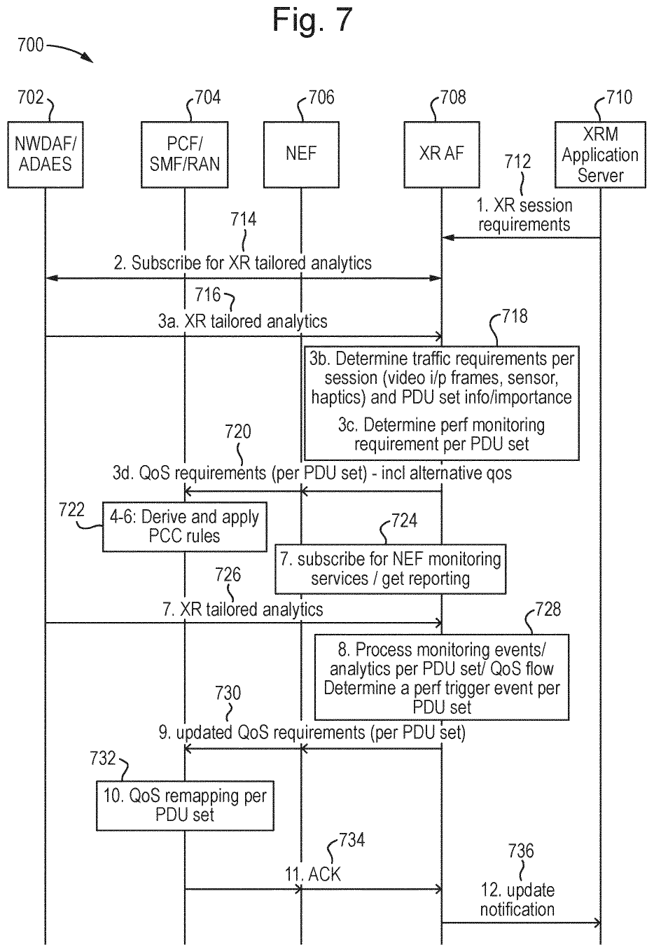

FIG. 7 is a schematic illustration illustrating a process 700 in which PDU set parameters/requirements are updated or influenced based on NWDAF/ADAES analytics.

The process 700 may involve an NWDAF and/or ADAES 702 hereinafter referred to as the NWDAF/ADAES, a PCF and/or SMF and/or RAN 704 hereinafter referred to as the PCF/SMF/RAN, a NEF 706, an XR AF 708, and an XRM application server 710.

The NWDAF/ADAES, the PCF/SMF/RAN 704, the NEF 706, the XR AF 708, and the XRM application server 710 may be the same as or in accordance with any network entity, function, or node described herein. For example, the NWDAF/ADAES, the PCF/SMF/RAN 704, the NEF 706, the XR AF 708, and the XRM application server 710 may be the same as the network node 300 shown in FIG. 3 and described in more detail earlier above.

At 712, the XRM application server 710 provides the application QoS/QoE requirements per XR service/session to the XR AF 708. The XR AF 608 is assumed in this embodiment to be a trusted 3rd party or MNO deployed AF.

At 714, the XR AF 708 subscribes for XR tailored analytics to the NWDAF/ADAES 702, e.g. based on the capability required. Such analytics may be related to stats/predictions on the optimal PDU set dimensioning and the setting of importance and QoS parameters per PDU set. The analytics may be based on historical data or real time measurements.

At 716, the XR AF 708 may receive analytics based on the subscription at 714, and based on the requirement received at 712.

At 718, the XR AF 708 determines the PDU set requirement.

At 720, based on the determined PDU set requirement, the XR AF 708 provides QoS requirements (e.g., PSDB and PSER) for packets of a PDU-set to the PCF/SMF/RAN 704. The XR AF 708 may provide information to identify the application (e.g. 5-tuple or application id) to the PCF/SMF/RAN 704. The XR AF 708 may also send to the PCF/SMF/RAN 704 an importance parameter for a PDU-set and/or information for the core network to identify packets belonging to a PDU-set. The XR AF 708 may also send to the PCF/SMF/RAN 704 PDU set information such as PDU set ID, the mobility pattern for the XR UF(s) of interest which may include a set of waypoints in the area of interest, and also possible alternative QoS parameters (different sets of QoS attributes) and their priorities per PDU set.

At 722, the PCF derives QoS rules for the XR application (i.e. use a 5QI for XR media traffic) and specific QoS requirements (which may include alternative QoS attributes and their priorities) for the PDU-set (optionally using a PDU set identification as given by the AF). The PCF configures the SMF accordingly. The PCF may incorporate the PCC rules (i.e. the derived rules) per importance of a PDU-set, which may be in accordance with information received from the XR AF 708 or based on operator configuration.

In this embodiment, the SMF establishes a QoS flow according to the QoS rules derived by the PCF and configures the UPF to route packets of the XR application to a QoS flow and, in addition, enable PDU-set handling. The SMF may additionally provide the QoS profile containing PDU-set QoS requirements to the RAN via the AMF. The UPF inspects the packets and determines packets belonging to a PDU-set (e.g. by inspecting the RTP packets). When the UPF detects packets of a PDU-set, the UPF marks the packets belonging to a PDU-set within a GTP-U header. The GTP-U header information includes a PDU-set sequence number and the size of the PDU set. The UPF may also determine the importance of the PDU-set either based on UPF implementation means, information provided by the AF or information provided as metadata from the application server. Based on the importance of the PDU-set, the UPF may route the traffic to a corresponding QoS flow (e.g. according to the rules received from the SMF) or include the importance of the PDU-set within a GTP-U header.

The RAN identifies packets belonging to a PDU set (e.g. based on the GTP-U marking) and handles the packets of the PDU-set according to the QoS requirements of the PDU-set provided by the SMF.

The following steps may occur at the runtime phase (i.e. while the XR session is running).

At 726, the XR AF 708 subscribes to network monitoring events and/or analytics related to different PDU sets/type of traffic within XR session. The XR AF 708 may thus receive network monitoring events and/or XR tailored analytics.

At 728, upon receiving a monitoring event and/or the analytics output of the NWDAF/ADAES 702, the XR AF 708 processes or evaluates the monitoring events and/or analytics. A monitoring event may include but is not limited to a QoS downgrade indication, or a network congestion expectation. Based on the target KPI(s) per XR sessions and per PDU set QoS targets, the XR AF 708 determines an action to be performed. This action may be updating of the QoS profile or making a request for more resources for one or more PDU sets. The objective of this action may be to ensure meeting the end-to-end XR session requirements (including multimodal traffic).

At 730, the determined action may be performed, e.g. by the XR AF 708. In this embodiment, the XR AF 708 sends the updated QoS requirements to the SMF 704 e.g. via NEF 706. This may include the possible change of the importance per PDU set. If this is a predicted QoS requirements change, this may be provided as an early notification indicating the time horizon for the expected QoS target update per PDU set.

At 732, the 5GC (i.e. SMF/PCF 704) updates PCC rules based on the XR AF request.

At 734, the 5GC (i.e. SMF/PCF 704) provides a response or acknowledgement (ACK) to the XR AF 708. This response may be provided via the NEF 706 or directly.

At 736, the XR AF 708 notifies the XR application server 710 of the updated QoS parameters per XR session. In this step, the notification may also include some expected/predicted performance downgrade and/or an alert to adapt the application behavior (for example, to adapt the encoding rate for video traffic e.g. in accordance with the determined action).

Thus, a process in which PDU set parameters/requirements are updated or influenced based on NWDAF/ADAES analytics is provided.

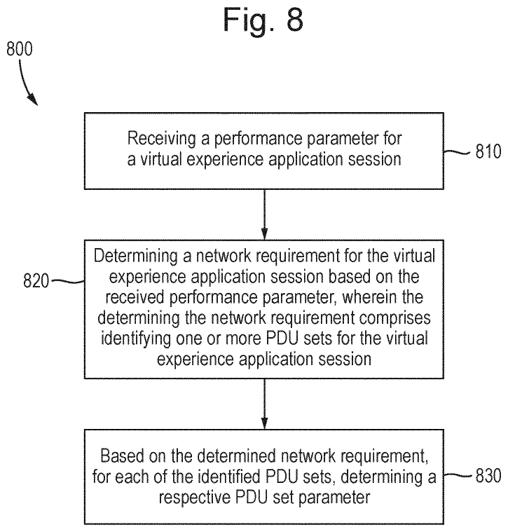

In an aspect, there is provided a method performed in an application entity of a wireless communication system or network. FIG. 8 is a process flow chart showing certain steps of the method 800. In certain embodiments, the method 800 may be performed by a processor executing program code, for example, a microcontroller, a microprocessor, a CPU, a GPU, an auxiliary processing unit, a FPGA, or the like. The method 800 is for managing performance of one or more virtual experience applications. The method comprises: receiving 810 a performance parameter (e.g., a QoS/QoE parameter or requirement) for a virtual experience application session, such as an XR, AR, VR or Metaverse application session; determining 820 a network requirement for the virtual experience application session based on the received performance parameter, wherein the determining the network requirement comprises identifying one of more protocol data unit, PDU, sets for the virtual experience application session; and, based on the determined network requirement, for each of the identified PDU sets, determining 830 a respective PDU set parameter. The PDU set parameter may comprise one or more QoS attributes for the PDU set, one or more importance parameters/rankings for the PDU set, and/or information for identifying packets belonging to the PDU set.

The method may further comprise transmitting, to at least one entity (e.g. to the PCF/SMF via the NEF, or to the UPF), either or both of (i) the one or more PDU set parameters, and/or (ii) configuration information. The configuration information may be based on the one or more PDU set parameters. The configuration information may be a configured monitoring requirement/request. The configuration information may be for configuring the monitoring, within the wireless communication system/network, of one or more parameters (e.g. monitoring events) related to one or more performance attributes of the one or more identified PDU sets. The entity may be an entity arranged to monitor or cause the monitoring of the one or more parameters related to the one or more performance attributes of the one or more identified PDU sets. The configuration information may be for configuring the monitoring, within the wireless communication system/network, of one or more monitoring events (e.g. a QoS downgrade indication/event/expectation, or a network congestion event or expectation, etc.) related to one or more performance attributes of the one or more identified PDU sets. The configuration information may specify or comprise the one or more monitoring events.

The method may further comprise obtaining and processing at least one monitoring parameter (e.g. measurements or analytics/statistics) corresponding to the one or more monitoring events, such as an indication that the event has or will occur and/or corresponding value.

The method may further comprise, responsive to obtaining and processing the at least one monitoring parameter, triggering an action within the wireless communication system/network. An objective of said action may be to ensure the performance parameter of the extended reality service is met. The action may comprise an action selected from the group of actions consisting of: updating (i.e. adapting) a respective PDU set parameter (e.g. a QoS requirement or profile) of one or more PDU set, and sending the updated PDU set parameter or parameters to the at least one entity; and requesting more resources for one or more of the PDU sets. The requesting of resources, e.g. additional resources, may comprise sending to the 5GC (e.g. to the SMF via the NEF or to the PCF via N5) a request for a change of the QoS profile mapped to the respective network session/PDU set or the update of the PCC rules to apply the new traffic policy. This may be as specified in 3GPP TS 23.502, in clause 4.15.6.6a: AF session with required QoS update procedure.

The method may further comprise performing said action.

The method may further comprise obtaining analytics related to a performance of one or more PDU sets. The identifying of the one of more PDU sets and/or or the determining of the respective PDU set parameters may be performed using the obtained analytics.

The configuration information may be for configuring the monitoring, within the wireless communication system/network, of the one or more parameters for one or more predefined video quality levels or encoding rates.

The configuration information may be for configuring the monitoring, within the wireless communication system/network, of the one or more parameters by one or more user equipment, UE, apparatuses.

The transmitting may comprise transmitting, to a UE or an application server serving a UE, the configuration information.

The performance parameter may be comprised in a subscription message or request.

The performance parameter is an application QoS or QoE requirement.

Each PDU set parameter may be selected from the group of parameters consisting of QoS attributes for a PDU set, an importance parameter/ranking for a PDU set, and information for identifying packets belonging to PDU set.

The transmitting may comprise transmitting, to a core network function (e.g. to a PCF or via the NEF, e.g. if the AF is untrusted), the one or more PDU set parameters. For example, a QoS requirement for packets of a PDU set, an importance parameter for a PDU-set, and/or information for the core network to identify packets belonging to a PDU-set, may be sent to the PCF. Additionally, information to identify the XR application, PDU set information such as PDU set ID, the mobility pattern for the XR UE(s) of interest, and/or possible alternative QoS parameters and, optionally, their priorities per PDU set, may also be send to the PCF.

In a further aspect, there is provided an application entity for a wireless communication system/network. The apparatus comprises a transceiver and a processor coupled to the transceiver. The processor and the transceiver are arranged to cause the application entity to: receive a performance parameter (e.g. a QoS/QoE parameter/requirement) for a virtual experience application session; determine a network requirement for the virtual experience application session based on the received performance parameter, wherein the determination of the network requirement comprises identifying one of more protocol data unit, PDU, sets for the virtual experience application session; and, based on the determined network requirement, for each of the identified PDU sets, determine a respective PDU set parameter. The PDU set parameter may include one or more QoS attributes for the PDU set, one or more importance parameter/ranking for the PDU set, and/or information for identifying packets belonging to the PDU set.

The processor and the transceiver may be further arranged to cause the application entity to transmit, to at least one entity, either or both of (i) the one or more PDU set parameters, and (ii) configuration information. The configuration information may be a configured monitoring requirement/request. The configuration information may be based on the one or more PDU set parameters. The configuration information may be for configuring the monitoring, within the wireless communication system/network, of one or more parameters (e.g. monitoring events) related to one or more performance attributes of the one or more identified PDU sets.

In a further aspect, there is provided a UE apparatus comprising a transceiver; and a processor coupled to the transceiver. The processor and the transceiver are arranged to cause the UE apparatus to: receive configuration information specifying, for each of one or more PDU sets of an virtual experience application session, one or more parameters (e.g. monitoring events) related to one or more performance attributes of that PDU set; and monitor the one or more parameters of the virtual experience application session in accordance with the received configuration information.

The UE may monitor the application QoS parameters (e.g. channel loss, delay, throughput, PER, etc.) for the XR application session and based on the configuration it may act by either providing a report periodically or responsive to event occurrence (for example, if a certain metric reaches a threshold, e.g. loss >X %, the UE may trigger a notification to the server)

The processor and the transceiver may be further arranged to cause the UE apparatus to, based on the configuration information, transmit a report on the monitored one or more parameters of the virtual experience application session.

The virtual experience application session may be a session between the UE apparatus (i.e. an XR device) and a server using a network session, or a session between the UE apparatus and another UE apparatus using a network session (e.g. a session between two XR devices using network-assisted device to device communication).

The above-described systems and methods tends to enable the XR application to set and dynamically adjust the QoS parameters for the application session comprising different types of traffic (video, audio, sensor data, haptics) to ensure meeting the XR service requirements.

A new capability and mechanism is provided at the enablement layer to allow the translation of XR application session requirements to QoS requirements per PDU set and cross-PDU sets (e.g. setting importance/priorities). Such capability also may require new application layer signaling from the XR UEs to monitor the performance. With the optional support of analytics, the XR enabler server/AF may proactively trigger application or network layer adaptions to ensure the XR service requirement is met. This tends to be applicable to mobile metaverse use cases, since it is expected that multiple XR users participate in mobile environments in the Metaverse application sessions; hence the dynamic configuration and adaptation of the per PDU set QoS requirement tends to be beneficial.

Conventionally, the behavior of AF/application layer entity and procedures/new APIs on top of the network for the QoS translation per PDU set is not considered. Also, the interactions with the UE for differentiated configuration of reporting per type of traffic within the XR application session is not considered.

In some embodiments, the XR enabler server (which may be a newly defined entity in SA6) plays a key role in the configuration of the PDU sets and QoS parameters and supports monitoring from the UE side and triggering the adaption of requirements dynamically.

In some embodiments, the XR AF (which may be as defined in SA2) acts a middleware AF between XR server and 5GS to translate the application QoS requirements to per PDU set requirements, and also uses analytics to pro-actively adapt network behavior to ensure meeting the XR requirements.

Further aspects of the invention are provided by the subject matter of the following clauses:
1. A method at an application entity for managing the performance of one or more extended reality applications. The method comprising:
receiving an XR application requirement;
determining a network QoS requirement based on the XR application requirement, wherein the network QoS requirement is a mapping to a plurality of PDU sets, a PDU set QoS requirement, an importance requirement or a combination thereof;
configuring a monitoring requirement based on the network QoS requirement, wherein the monitoring requirement comprises a plurality of monitoring events related to at least one performance attribute for at least one PDU set of the XR application session;
transmitting the configured monitoring requirement and/or the network QoS requirement to at least one entity (wherein the entity may be a network or XR application entity which is assigned to monitor at least one performance attribute based on the requirement);
obtaining at least on monitoring parameter corresponding to the configured monitoring event for at least one PDU set of the XR application session;
triggering a network QoS requirement adaption based on the monitoring event; and
sending the updated network QoS requirement to a network and/or XR application entity.
2. The method of any preceding clause, further comprising obtaining and using analytics (e.g. for the steps of determining, configuring, and/or triggering).
3. The method of any preceding clause, wherein the monitoring and network requirement can be provided per given quality/encoding rate, or for a list of qualities/encoding rates.
4. The method of any preceding clause, further comprising subscribing to receive XR application requirements.
5. The method of any preceding clause, further comprising sending to a UE the mapping of PDU set/media type/traffic type and/or importance, which may be used to the UL.
6. The method of any preceding clause, wherein the XR application requirements are QoS or QoE requirements.
7. The method of any preceding clause, wherein the sending is to a network via user plane or control plane.
8. The method of any preceding clause, wherein the sending is to one or more UEs and/or an XR application server.
9. The method of any preceding clause, wherein the configuring can be after a request/response between the application entity and a UE.
10. A network arranged to perform the method of any preceding clause.

It should be noted that the above-mentioned methods and apparatus illustrate rather than limit the invention, and that those skilled in the art will be able to design many alternative arrangements without departing from the scope of the appended claims. The word “comprising” does not exclude the presence of elements or steps other than those listed in a claim, “a” or “an” does not exclude a plurality, and a single processor or other unit may fulfil the functions of several units recited in the claims. Any reference signs in the claims shall not be construed so as to limit their scope.

Further, while examples have been given in the context of particular communication standards, these examples are not intended to be the limit of the communication standards to which the disclosed method and apparatus may be applied.

For example, while specific examples have been given in the context of 3GPP, the principles disclosed herein can also be applied to another wireless communication system, and indeed any communication system which uses routing rules.

The method may also be embodied in a set of instructions, stored on a computer readable medium, which when loaded into a computer processor, Digital Signal Processor (DSP) or similar, causes the processor to carry out the hereinbefore described methods.

The described methods and apparatus may be practiced in other specific forms. The described methods and apparatus are to be considered in all respects only as illustrative and not restrictive. The scope of the invention is, therefore, indicated by the appended claims rather than by the foregoing description. All changes which come within the meaning and range of equivalency of the claims are to be embraced within their scope.

The following abbreviations are relevant in the field addressed by this document:
UE User Equipment
PDU-set Protocol Data Unit set
UL Uplink
DL Downlink
QoS Quality of Service
XR Extended Reality
PSDB PDU Set Delay Budget
PDB Packet Delay Budget
PSER PDU Set Error Rate
NWDAF Network Data Analytics Function
UPF User Plane Function
SMF Session Management Function
ADAES Application Data Analytics Enablement Server
ADAEC Application Data Analytics Enablement Client
XRM XR and Media
SEAL Service Enabler Architecture Layer
MOS Mean Opinion Score

1. A method performed by an application entity of a wireless communication system, the method comprising:
receiving a performance parameter for a virtual experience application session;
determining, based at least in part on one or more identified protocol data unit (PDU) sets, a network requirement for the virtual experience application session based on the received performance parameter; and
determining, based on the determined network requirement for each of the one or more identified PDU sets, a respective PDU set parameter.

2. The method of claim 1, further comprising:
transmitting at least one of one or more PDU set parameters, or configuration information based on the one or more PDU set parameters, and wherein the configuration information configures monitoring of one or more parameters related to one or more performance attributes of the one or more identified PDU sets.

3. The method of claim 2, wherein the transmitting is to an entity arranged to monitor or cause the monitoring of the one or more parameters related to the one or more performance attributes of the one or more identified PDU sets.

4. The method of claim 3, wherein the configuration information configures the monitoring of one or more monitoring events related to the one or more performance attributes of the one or more identified PDU sets.

5. The method of claim 4, further comprising:
obtaining and processing at least one monitoring parameter corresponding to the one or more monitoring events; and
responsive to the obtaining and processing the at least one monitoring parameter, triggering an action within the wireless communication system.

6. The method of claim 5, wherein the action includes at least one of updating a respective PDU set parameter for the one or more identified PDU sets, sending updated one or more respective PDU set parameters to the at least one entity, or requesting more resources for one or more of the identified PDU sets.

7. The method of claim 2, wherein the configuration information configures the monitoring of the one or more parameters for one or more predefined video quality levels or encoding rates.

8. (canceled)

9. The method of claim 2, wherein the transmitting comprises transmitting, to a user equipment (UE) or an application server serving the UE, the configuration information.

10. The method of claim 2, wherein the transmitting comprises transmitting, to a core network function, the one or more PDU set parameters.

11. The method of claim 1, further comprising:
obtaining analytics related to a performance of one or more of the one or more identified PDU sets, wherein at least one of the one of more identified PDU sets are identified, or the respective PDU set parameter is determined based at least in part on the obtained analytics.

12. The method of claim 1, wherein the performance parameter is included in a subscription request, or at least one of is an application quality of service (QoS) requirement or a quality of experience (QoE) requirement.

13. (canceled)

14. The method of claim 1, wherein each PDU set parameter is selected from a group of parameters including quality of service (QoS) attributes for a PDU set, one or more of an importance parameter or an importance ranking for the PDU set, and information for identifying packets belonging to the PDU set.

15. An application entity for wireless communication, comprising:
at least one memory; and
at least one processor coupled with the at least one memory and configured to cause the application entity to:
receive a performance parameter for a virtual experience application session;
determine, based at least in part on one or more identified protocol data unit (PDU) sets, a network requirement for the virtual experience application session based on the received performance parameter; and
determine, based on the determined network requirement for each of the one or more identified PDU sets, a respective PDU set parameter.

16. The application entity of claim 15, wherein the at least one processor is configured to cause the application entity to transmit at least one of one or more PDU set parameters, or configuration information based on the one or more PDU set parameters, and wherein the configuration information configures monitoring of one or more parameters related to one or more performance attributes of the one or more identified PDU sets.

17. A user equipment (UE) for wireless communication, comprising:
at least one memory; and
at least one processor coupled with the at least one memory and configured to cause the UE to:
receive configuration information specifying, for each of one or more protocol data unit (PDU) sets of a virtual experience application session, one or more parameters related to one or more performance attributes of a PDU set; and
monitor the one or more parameters of the virtual experience application session in accordance with the received configuration information.

18. The UE of claim 17, wherein the at least one processor is configured to cause the UE to transmit, based on the configuration information, a report on the monitored one or more parameters of the virtual experience application session.

19. The UE of claim 17, wherein the virtual experience application session is a session between the UE and a server using a network session, or a session between the UE and another UE using the network session.

20. A method performed by a user equipment (UE), the method comprising:
receiving configuration information specifying, for each of one or more protocol data unit (PDU) sets of a virtual experience application session, one or more parameters related to one or more performance attributes of a PDU set; and
monitoring the one or more parameters of the virtual experience application session in accordance with the received configuration information.

21. The application entity of claim 16, wherein the at least one processor is configured to cause the application entity to transmit to an entity configured to monitor or cause the monitoring of the one or more parameters related to the one or more performance attributes of the one or more identified PDU sets.

22. The application entity of claim 21, wherein the configuration information configures the monitoring of one or more monitoring events related to the one or more performance attributes of the one or more identified PDU sets.
